(19) United States
(12) Patent Application Publication
(10) Pub. No.: US 2009/0127043 A1
(43) Pub. Date: May 21, 2009

(54) INSULATOR FOR VEHICLE SUSPENSION SYSTEM

(76) Inventor: Daniel G. Dickson, Bloomfield, MI (US)

Correspondence Address: BASF AKTIENGESELLSCHAFT, CARL-BOSCH STRASSE 38, 67056 LUDWIGSHAFEN, LUDWIGSHAFEN, 69056, DE

(21) Appl. No.: 11/943,654

(22) Filed: Nov. 21, 2007

(51) Int. Cl. F16F 7/10; F16F 7/00

(52) U.S. Cl. 188/380; 267/202

(57) ABSTRACT

A wheel suspension system for a vehicle includes a mounting base and a striking base spaced from each other and moveable relative to each other along an arced line of motion. An insulator is coupled to and extends from the mounting base. The insulator is formed of an elastomeric material for compression between the mounting base and the striking base, i.e., the insulator is compressed along the arced line of motion between the mounting base and the striking base. The insulator includes a core portion extending along an axis and a ridge portion extending laterally from the core portion about the axis. The ridge portion extends circumferentially along the core portion at an acute angle relative to the base plane for guiding the compression of the insulator along the arced line of motion to uniformly distribute compressive forces within the insulator thereby increasing the durability and reliability of the insulator.

### BACKGROUND OF THE INVENTION

1. Field of the Invention

The present invention relates to an insulator for a wheel suspension system of a vehicle. Specifically, the vehicle includes a mounting base and a striking base with the mounting and striking bases moveable relative to each other along an arced line of motion and with the insulator coupled to the mounting base for absorbing impacts between the mounting and striking bases.

2. Description of the Related Art

Insulators are used for absorbing loads and dampening vibrations in vehicles. Such insulators include jounce bumpers for disposition in wheel suspension systems. The wheel suspension system includes a mounting base and a striking base spaced from and moveable relative to the mounting base. The insulator is coupled to the mounting base for compression between the mounting base and the striking base when the striking base contacts the insulator during movement of the mounting base relative to the striking base.

Insulators of these types are formed from elastomeric materials such as rubber or microcellular polyurethane such that the insulator compresses and absorbs loads between the mounting base and the striking base. When the insulator formed of elastomeric material is subjected to compressive forces, the insulator collapses. When the compressive forces are removed from the insulator, the insulator returns to the original shape and thereby regains its form.

The insulator includes a core portion extending along an axis and at least one ridge portion extending laterally from the core portion about the axis. An example of such an insulator is that disclosed in U.S. Pat. No. 5,052,665 to Sakuragi. The ridge portion guides the compression of the core portion such that the core portion uniformly collapses during compression. In other words, the ridge portion aids in preventing bulging and/or bending of the core portion during compression.

Prior art insulators formed of elastomeric materials are designed for linear motion and compression, i.e., the mounting base and the striking base move toward and away from each other along a straight line. As such, the ridge portion extends annularly about the core portion relative to the axis. In such a configuration, the insulator travels along a straight line so that the annular ridge portion guides the core portion to collapse linearly and compress uniformly.

Some wheel suspension systems are arranged such that the mounting base and the striking base move relative to each other in an arced line of motion. In such a system, the insulator is compressed in the arced line of motion. In a twist axle suspension system, i.e., a live axle, the insulator is compressed in the arced line of motion. Other examples where the insulator is compressed in the arced line of motion includes when the insulator is mounted to a control arm or to a leaf spring. Insulators of the prior art can lack durability when subject to such compression along the arced line of motion. When moving along the arced line of motion, the insulator contacts the striker surface angularly. As such, upon contact with the striker surface, a portion of the insulator disposed on the interior of the arced line of motion is in compression and a portion of the insulator disposed on the exterior of the arced line of motion is in tension. Nonuniform compression causes the portion on the interior of the arced line of motion to bulge. Additionally, tension is destructive to the elastomeric material by causing the elastomeric material to crack or tear so that the portion on the exterior of the arced line of motion cracks or tears. In such a configuration, the ridge portion fails to guide the core portion toward linear collapse and uniform compression.

Accordingly, it would be desirable to manufacture an insulator formed of elastomeric material that is configured to be more durable and reliable than insulators contemplated in the prior art when mounted in a wheel suspension system including a mounting base and a striking base that move relative to each other in an arced line of motion.

### SUMMARY OF THE INVENTION AND ADVANTAGES

The present invention is an insulator for a wheel suspension system of a vehicle. The wheel suspension system includes a mounting base and a striking base moveable relative to each other along an arced line of motion. The insulator includes a mounting surface defining a mounting plane for coupling to the mounting base. A core portion extends from the mounting surface along an axis and is formed of elastomeric material for compression between the mounting base and the striking base when the striking base contacts the insulator during movement of the mounting base relative to the striking base along the arced line of motion. A ridge portion extends laterally from the core portion about the axis and extends circumferentially along the core portion at an acute angle relative to the mounting plane for guiding the compression of the insulator along the arced line of motion.

Accordingly, the compressive forces are distributed within the insulator when the insulator is compressed along the arced line of motion. The ridge portion extending at the acute angle relative to the mounting plane guides the compression of the core portion such that the insulator compresses uniformly. In other words, the ridge portion distributes the compression within the insulator. As such, the insulator uniformly compresses when subject to compressive forces along the arced line of motion thereby increasing the durability and reliability of the insulator. The uniform compression eliminates bulging, which is caused by uneven compression in the insulator, and eliminates cracking and tearing, which is caused by tension in the insulator.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1A is a perspective view of an insulator;

FIG. 1B is a cross-sectional view of the insulator of FIG. 1A;

FIG. 2 is a cross-sectional view of a wheel suspension system in an uncompressed state;

FIG. 3 is a cross-sectional view of the wheel suspension system in a partially compressed state;

FIG. 4A is a perspective view of another embodiment of the insulator;

FIG. 4B is a cross-sectional view of the insulator of FIG. 4A;

FIG. 5A is a perspective view of another embodiment of the insulator;

FIG. 5B is cross-sectional view of the insulator of FIG. 5B;

FIG. 6A is a perspective view of another embodiment of the insulator; and

FIG. 6B is a side view of the insulator of FIG. 6A.

### DETAILED DESCRIPTION OF THE INVENTION

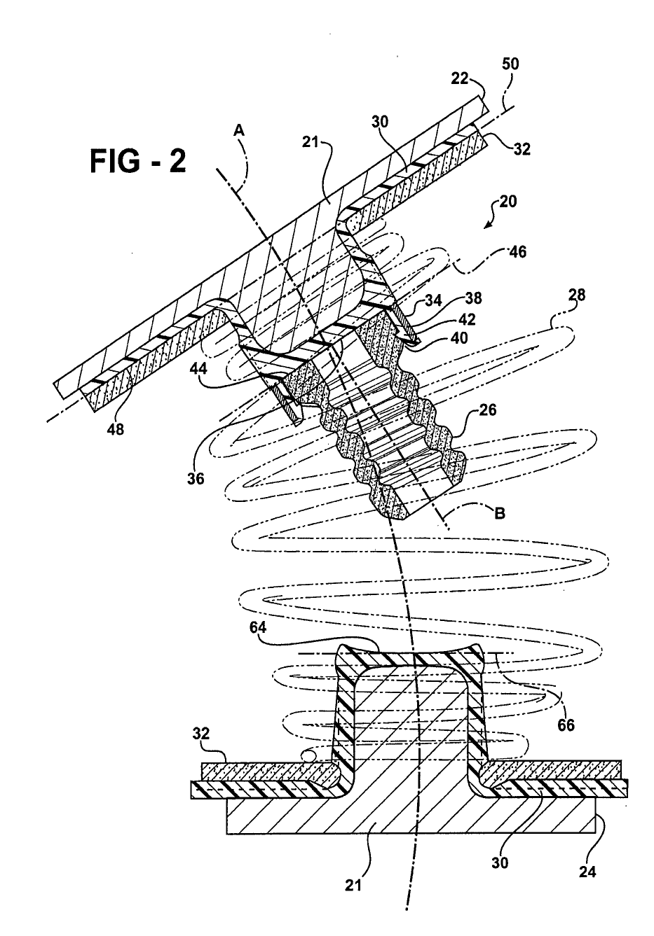

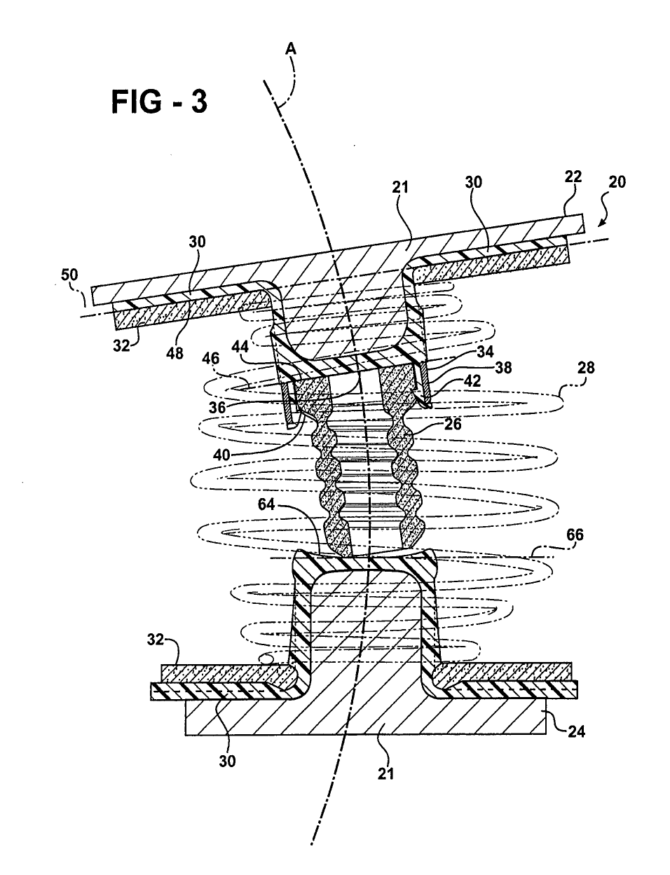

Referring to the Figures, wherein like numerals indicate like parts throughout the several views, a wheel suspension system 20 for a vehicle is generally shown. As shown in FIGS. 2-3, the wheel suspension system 20 includes a mounting base 22 and a striking base 24 spaced from and moveable relative to the mounting base 22. The mounting and striking bases 22, 24 are, for example, mounted to mounting protrusions 21 of the vehicle. An insulator 26 is coupled to and extends from the mounting base 22. The insulator 26 compresses between the mounting base 22 and the striking base 24 when the striking base 24 contacts the insulator 26 during the movement of the mounting base 22 relative to the striking base 24. For example, the mounting base 22 and the striking base 24 may move relative to each other when the vehicle drives over an uneven driving surface. Those skilled in the art may also refer to such an insulator 26 as a jounce bumper.

The mounting and striking bases 22, 24 are moveable relative to each other along an arced line of motion A. Types of wheel suspension systems 20 that include mounting and striking bases 22, 24 that are moveable relative to each other along an arced line of motion A are known to those skilled in the art. Examples of such types of wheel suspension systems 20 include a twist axle suspension system, i.e., a live axle suspension system, an independent suspension system, and wheel suspension systems 20 including the insulator 26 mounted to a control arm or to a leaf spring of the vehicle.

The wheel suspension system 20 may include a coil spring 28 extending between the mounting and striking bases 22, 24. For illustrative purposes, the coil spring 28 is shown in phantom in FIGS. 2-3. The mounting base 22 and the striking base 24 each include a spring seat 30 with the coil spring 28 extending between the spring seats 30. A spring isolator 32 is coupled to the mounting base 22. The coil spring 28 rests on the spring isolator 32 and the spring isolator 32 absorbs vibration and force delivered by the coil spring 28 to the mounting base 22.

The mounting base 22 includes a cup 34. The cup 34 has a support surface 36 and a ring 38 extending from the support surface 36. The support surface 36 and the ring 38 define a pocket 40 and the pocket 40 receives the insulator 26. Specifically, the insulator 26 is cylindrical and the pocket 40 of the cup 34 is cylindrical. The cup 34 defines a plurality of tabs 42 disposed about the ring 38 and extending into the pocket 40 toward the insulator 26. The tabs 42 engage the insulator 26 to retain the insulator 26 in the pocket 40. Alternatively, the cup 34 defines a continuous flange for engaging the insulator 26 to retain the insulator 26 in the pocket 40. In any event, it should be appreciated that the insulator 26 can be retained in the pocket 40 in any fashion without departing from the nature of the present invention. The mounting base 22 is formed of a polymeric material such as nylon, isoprene, polypropylene, or polyurethane. More specifically, the mounting base 22 is formed of thermoplastic polyurethane. Alternatively, the mounting base 22 is formed of metal such as steel. However, it should be appreciated that the mounting base 22 may be formed of any material without departing from the nature of the present invention.

The insulator 26 presents a mounting surface 44 for coupling to the mounting base 22. The mounting surface 44 defines a mounting plane 46. The mounting surface 44 of the insulator 26 and the support surface 36 of the cup 34 are planar and the mounting surface 44 abuts the support surface 36.

The mounting base 22 presents a base surface 48 defining a base plane 50. As shown in FIGS. 2-3, the spring seat 30 presents the base surface 48. In the configuration shown in the Figures, the base surface 48 presented by the spring seat 30 is planar. It should be appreciated that the base surface 48 need not be a continuous planar surface but does extend along the base plane 50. In any event, the base plane 50 moves along the arced line of motion A when the mounting and striking bases 22, 24 move relative to each other along the arced line of motion A. The insulator 26 extends perpendicularly relative to the base plane 50.

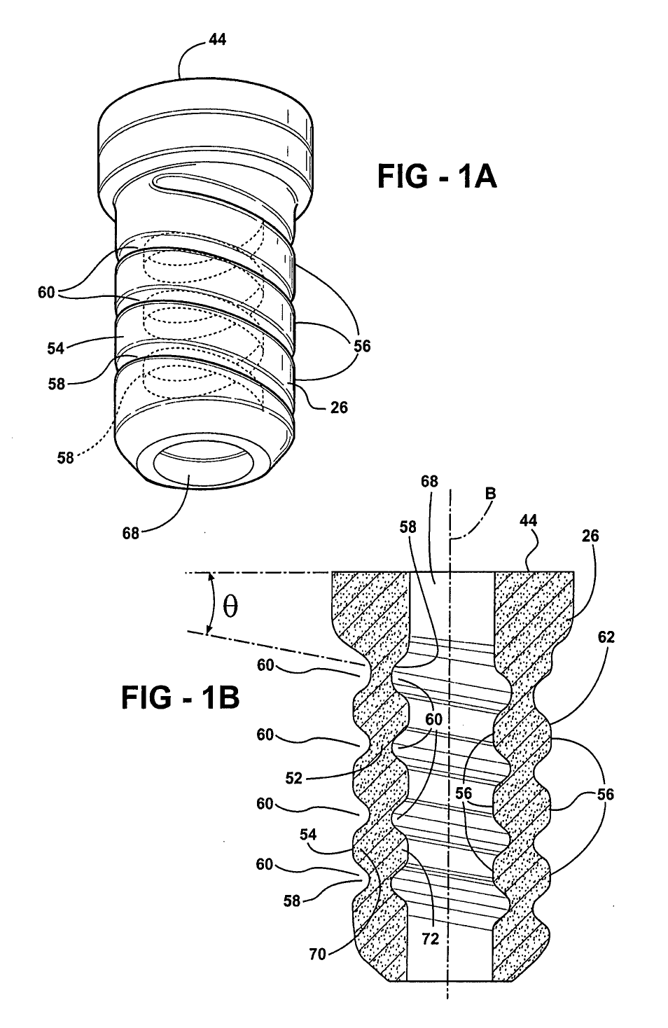

Referring to FIGS. 1A-3, the insulator 26 includes a core portion 52 extending along an axis B and a ridge portion 54 extending laterally from the core portion 52 about the axis B. The ridge portion 54 controls and guides the compression of the insulator 26 such that the insulator 26 uniformly collapses during compression. In other words, the ridge portion 54 aids in preventing bulging and/or bending of the insulator during compression. As shown in the Figures, the ridge portion 54 is integral with the core portion 52, i.e., the ridge portion 54 and the core portion 52 are formed as a one-piece insulator 26. However, it should be appreciated that ridge portion 54 and the core portion 52 may be formed separately and subsequently attached to each other.

The ridge portion 54 extends circumferentially along the core portion 52 at an acute angle θ relative to the base plane 50 for guiding the compression of the insulator 26 along the arced line of motion A. In other words, because the mounting base 22 and the striking base 24 move relative to each other along the arced line of motion A, an insulator of the prior art is nonuniformly compressed between the mounting base 22 and the striking base 24. With the insulator 26 of the present invention, the ridge portion 54 extending circumferentially along the core portion 52 at the acute angle θ relative to the base plane 50 distributes compressive forces in the insulator 26 thereby improving the reliability and durability of the insulator 26. In other words, when subject to compressive forces, the core portion 52 collapses and the ridge portion 54 guides the collapse of the core portion 52 for uniform compression in the core portion 52.

With the insulator 26 of the present invention, the extension of the ridge portion 54 along the acute angle θ relative to the base plane 50 achieves even distribution of the compressive forces to reduce or eliminate compression of the portion on the interior and tension of the portion of the exterior. As a result, the extension of the ridge portion 54 along the acute angle θ reduces or eliminates the bulging of the portion of the interior and the cracking and/or tearing of the portion of the exterior.

The ridge portion 54 extends helically about the axis B to define a plurality of ridge sections 56 with a valley 58 formed between consecutive ridge sections 56. Specifically, each ridge section 56 extends one revolution about the core portion 52. Each ridge section 56 extends continuously about the core portion 52 and preferably integrally connects to an adjacent ridge section 56. Each of the ridge sections 56 extend at the acute angle θ relative to the base plane 50.

The valley 58 extends helically about the axis B interposed with the ridge sections 56 to define a plurality of valley sections 60. Each of the ridge sections 56 has a crest 62 with each crest 62 spaced axially along the axis B and wherein each of the valley sections 60 extends arcuately and concavely between consecutive crests 62. In other words, the insulator 26 is threaded, i.e., fluted, as defined by the ridge portion 54 and the valley 58.

The striking base 24 presents a striker surface 64 defining a striker plane 66 for contacting the insulator 26. FIG. 2 shows the wheel suspension system 20 in an uncompressed state, i.e., with the insulator 26 spaced from the striker surface 64 of the striking base 24. FIG. 3 shows the wheel suspension system 20 in a partially compressed state, i.e., with the insulator 26 contacting the striker surface 64 of the striking base 24.

As shown in FIG. 3, the ridge portion 54 extends in parallel with the striker plane 66 when the striking base 24 contacts the insulator 26. As such, as the mounting base 22 and the striking base 24 compress the insulator 26, the ridge portion 54 forces the core portion 52 to collapse generally linearly as the mounting base 22 and the striking base 24 move relative to each other along the arced line of motion A. The acute angle θ of the ridge portion 54 may be designed such that the ridge portion 54 extends in parallel with the striker plane 66 when the striking base 24 contacts the insulator 26. As such, the magnitude of the acute angle θ may vary by design. For example, the acute angle θ may be between 0 and 60 degrees. However, it should be appreciated that the acute angle θ may have any magnitude less than 90 degrees without departing from the nature of the present invention.

In the embodiment shown in FIGS. 1A-B, the core portion 52 defines a bore 68 and the ridge portion 54 is further defined as a first ridge portion 70 and a second ridge portion 72. The first ridge portion 70 extends outwardly from the core portion 52 and the second ridge portion 72 extends inwardly from the core portion 52 into the bore 68. As best shown in FIG. 1B, the first and second ridge portions 70, 72 are axially aligned with each other along the axis B. In other words, the crests 62 of the first ridge portion 70 and the crests 62 of the second ridge portion 72 are axially aligned with each other along the axis B. Similarly, the valleys 58 between the first ridge portion 70 and the valley 58 between the second ridge portion 72 are axially aligned with each other along the axis B.

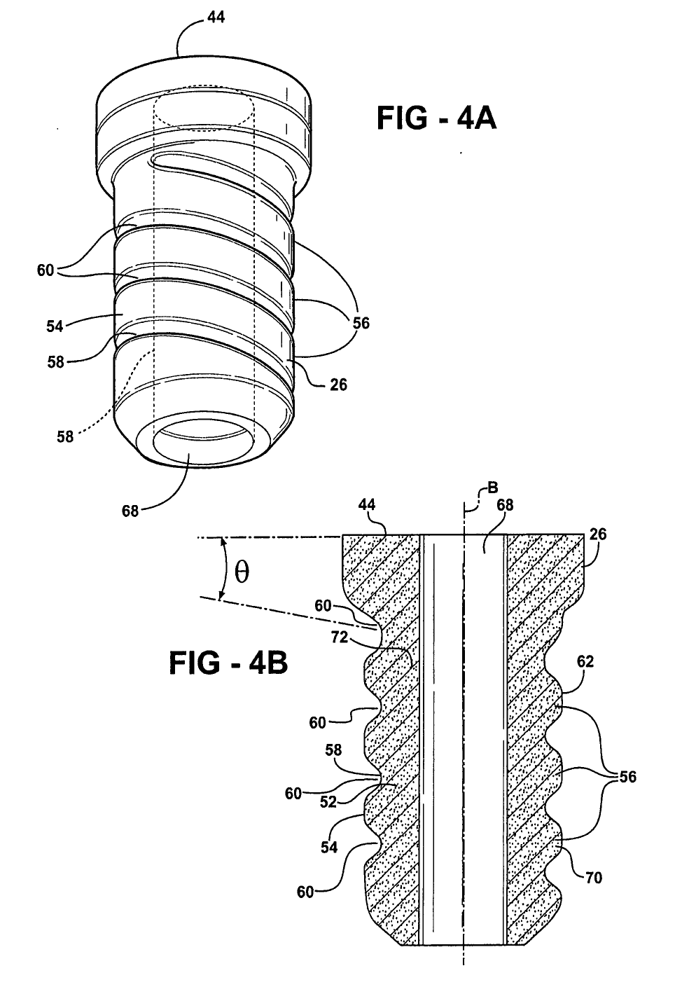

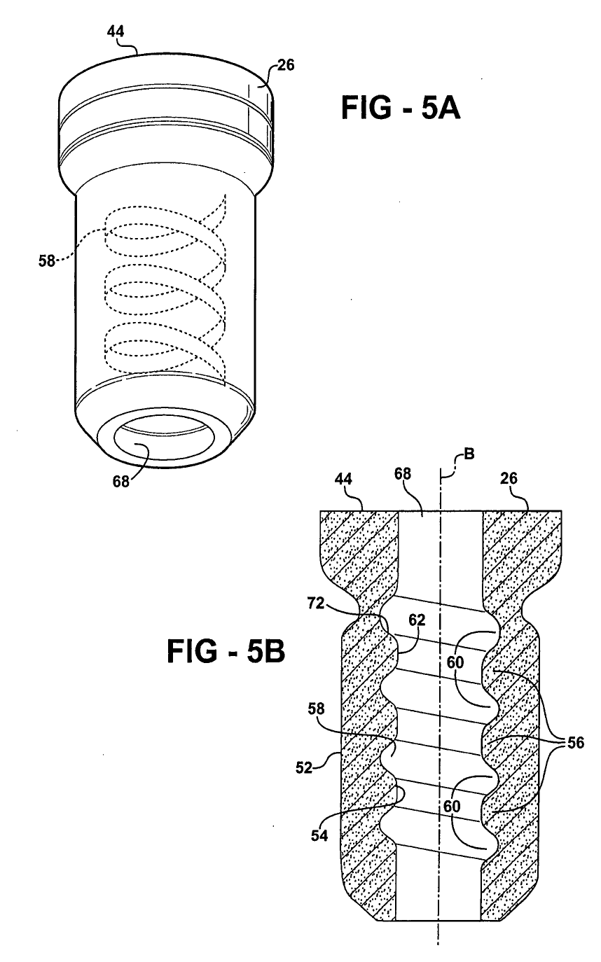

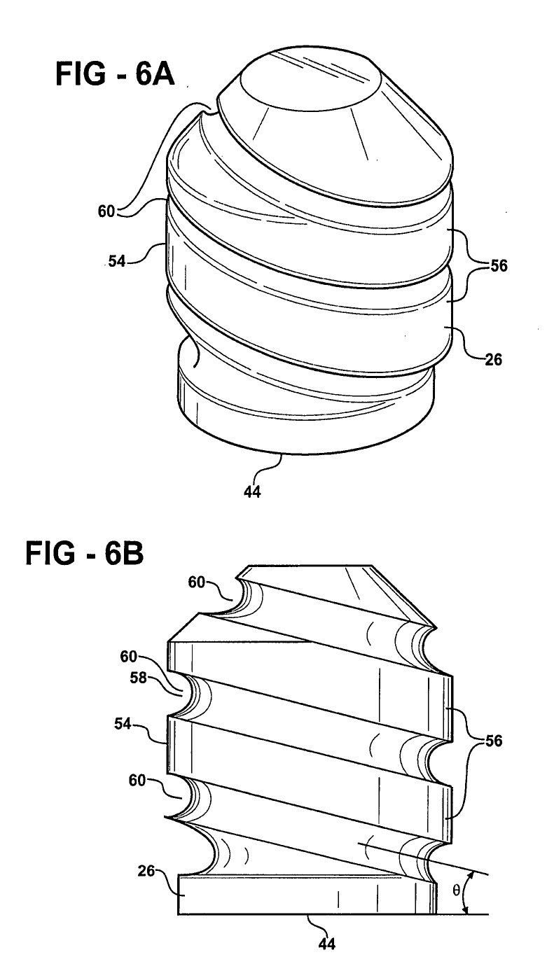

In the embodiment shown in FIGS. 4A-B, the ridge portion 54 extends outwardly from the core portion 52. In such an embodiment, as best shown in FIG. 4B, the bore 68 is smooth. Alternatively, in the embodiment shown in FIGS. 5A-B, the ridge portion 54 extends inwardly from the core portion 52 into the bore 68. In the embodiment shown in FIGS. 6A-B, the insulator 26 is solid, i.e., the core portion 52 does not define the bore 68. It should be appreciated that the ridge portion 54 and the core portion 52 may be arranged in any fashion such that the ridge portion 54 extends circumferentially along the core portion 52 at the acute angle θ relative to the base plane 50 without departing from the nature of the present invention.

The insulator 26 is formed of an elastomeric material. Specifically, the insulator 26 is preferably formed of microcellular polyurethane (MCU). MCU provides several advantages over alternative materials. Specifically, MCU has a microcellular structure, i.e., the MCU presents cell walls defining cells, or void space. When not subject to compressive forces, the cell walls have an original shape and the cells are generally filled with air. When the insulator 26 formed of MCU is subjected to compressive forces, the cell walls are collapsed and air evacuates from the cells and the insulator 26 is thereby deformed. When the compressive forces are removed from the insulator 26, the cell walls return to the original shape and the insulator 26 thereby regains its form. Because the cell walls collapse when subject to compressive forces, the insulator 26 experiences minimal bulge when compressed. In addition, at relatively low loads the insulator 26 compresses and absorbs loads, i.e. the MCU has a progressive load deflection curve, i.e., characteristic. Because the cell walls are collapsing, as the load increases, the insulator 26 becomes less compressible. When the cell walls are completely collapsed, the insulator 26 is not compressible and thereby provides a block height.

For example, the MCU is of the type manufactured by BASF Corporation under the tradename Cellasto®. The MCU is formed from a two-step process. In the first step of the process, an isocyanate prepolymer is formed by reacting a polyol and an isocyanate. The polyol is polyester, and alternatively is polyether. The isocyanate is monomeric methyldiphenyl diisocyanate, and alternatively is naphthalene diisocyanate. However, it should be appreciated that the isocyanate can be of any type without departing from the nature of the present invention. In the second step of the process, the isocyanate prepolymer reacts with water to generate carbon dioxide and the carbon dioxide forms the cells of the MCU.

For example, polyester polyols are produced from the reaction of a dicarboxylic acid and a glycol having at least one primary hydroxyl group. For example, dicarboxylic acids that are suitable for producing the polyester polyols are selected from the group of, but are not limited to, adipic acid, methyl adipic acid, succinic acid, suberic acid, sebacic acid, oxalic acid, glutaric acid, pimelic acid, azelaic acid, phthalic acid, terephthalic acid, isophthalic acid, and combinations thereof. For example, glycols that are suitable for producing the polyester polyols are selected from the group of, but are not limited to, ethylene glycol, butylene glycol, hexanediol, bis(hydroxymethylcyclohexane), 1,4-butanediol, diethylene glycol, 2,2-dimethyl propylene glycol, 1,3-propylene glycol, and combinations thereof. The polyester polyol has a hydroxyl number of from 30 to 130, a nominal functionality of from 1.9 to 2.3, and a nominal molecular weight of from 1000 to 3000. Specific examples of polyester polyols suitable for the subject invention include Pluracol® Series commercially available from BASF Corporation of Florham Park, N.J.

For example, polyether polyols are produced from the cyclic ether propylene oxide, and alternatively ethylene oxide or tetrahydrofuran. Propylene oxide is added to an initiator in the presence of a catalyst to produce the polyester polyol. Polyether polyols are selected from the group of, but are not limited to, polytetramethylene glycol, polyethylene glycol, polypropylene glycol, and combinations thereof. The polyether polyol has a hydroxyl number of from 30 to 130, a nominal functionality of from 1.8 to 2.3, and a nominal molecular weight of from 1000 to 5000. Specific examples of polyether polyols suitable for the subject invention include Pluracol® 858, Pluracol® 538, Pluracol® 220, Pluracol® TP Series, Pluracol® GP Series, and Pluracol® P Series commercially available from BASF Corporation of Florham Park, N.J.

For example, diisocyanates are selected from the group of, but are not limited to, 4,4′-diphenylmethane diisocyanate, 2,4′-diphenylmethane diisocyanate, ethylene diisocyanate, ethylidene diisocyanate, propylene diisocyanate, butylene diisocyanate, cyclopentylene-1,3-diisocyanate, cyclohexylene-1,4-diisocyanate, cyclohexylene-1,2-diisocyanate, 2,4-toluoylene diisocyanate, 2,6-toluoylene diisocyanate, 2,2-diphenylpropane-4,4′-diisocyanate, p-phenylene diisocyanate, m-phenylene diisocyanate, xylylene diisocyanate, 1,4-naphthylene diisocyanate, 1,5-naphthylene diisocyanate, diphenyl-4,4′-diisocyanate, azobenzene-4,4′-diisocyanate, diphenylsulfone-4,4′-diisocyanate, dichlorohexamethylene diisocyanate, tetramethylene diisocyanate, pentamethylene diisocyanate, hexamethylene diisocyanate, 1-chlorobenzene-2,4-diisocyanate, furfurylidene diisocyanate, and combinations thereof. Specific examples of diisocyanates suitable for the subject invention include Lupranate® 5143, Lupranate® MM103, and Lupranate® R2500U commercially available from BASF Corporation of Florham Park, N.J.

The monomeric methyldiphenyl diisocyanate is selected from the group of 4,4′-diphenylmethane diisocyanate, 2,4′-diphenylmethane diisocyanate, and combinations thereof. Specific examples of monomeric methyldiphenyl diisocyanates suitable for the subject invention include Lupranate® M and Lupranate® MS commercially available from BASF Corporation of Florham Park, N.J. The monomeric methyldiphenyl diisocyante may also be modified with carbonimide. Specific examples of carbonimide-modified monomeric methyldiphenyl diisocyante include Lupranate® 5143 and Lupranate® MM103 commercially available from BASF Corporation of Florham Park, N.J.

The invention has been described in an illustrative manner, and it is to be understood that the terminology which has been used is intended to be in the nature of words of description rather than of limitation. Obviously, many modifications and variations of the present invention are possible in light of the above teachings, and the invention may be practiced otherwise than as specifically described.

What is claimed is:

1. A wheel suspension system for a vehicle, said wheel suspension system comprising:
a mounting base presenting a base surface defining a base plane;
a striking base spaced from said mounting base with said striking and mounting bases moveable relative to each other along an arced line of motion; and
an insulator formed of elastomeric material with said insulator coupled to and extending from said mounting base for compressing between said mounting base and said striking base when said striking base contacts said insulator during movement of said mounting base relative to said striking base along said arced line of motion, and said insulator including a core portion extending along an axis and a ridge portion extending laterally from said core portion about said axis;
said ridge portion extending circumferentially along said core portion at an acute angle relative to said base plane for guiding the compression of said insulator along said arced line of motion.

2. The wheel suspension system as set forth in claim 1 wherein said ridge portion extends helically about said axis to define a plurality of ridge sections with a valley formed between consecutive ridge sections.

3. The wheel suspension system as set forth in claim 2 wherein said valley extends helically about said axis interposed with said ridge sections to define a plurality of valley sections.

4. The insulator as set forth in claim 3 wherein each of said ridge sections has a crest with each crest spaced axially along said axis and wherein each of said valley sections extends arcuately between consecutive crests.

5. The wheel suspension system as set forth in claim 2 wherein each ridge section extends one revolution about said core portion.

6. The wheel suspension system as set forth in claim 5 wherein each ridge section extends continuously about said core portion.

7. The wheel suspension system as set forth in claim 1 wherein said ridge portion extends outwardly from said core portion.

8. The wheel suspension system as set forth in claim 1 wherein said core portion defines a bore with said ridge portion extending inwardly from said core portion into said bore.

9. The wheel suspension system as set forth in claim 1 wherein said core portion defines a bore and wherein said ridge portion is further defined as a first ridge portion and a second ridge portion with said first ridge portion extending outwardly from said core portion and with said second ridge portion extending inwardly from said core portion into said bore.

10. The wheel suspension system as set forth in claim 9 wherein said first and second ridge portions are axially aligned with each other along said axis.

11. The wheel suspension system as set forth in claim 1 wherein said striking base presents a striker surface defining a striker plane for contacting said insulator and wherein said ridge portion extends in parallel with said striker plane when said striking base contacts said insulator.

12. The wheel suspension system as set forth in claim 1 wherein said insulator is formed of microcellular polyurethane.

13. The wheel suspension system as set forth in claim 1 wherein said ridge portion is integral with said core portion.

14. An insulator for a wheel suspension system of a vehicle with the suspension system having a mounting base and a striking base moveable relative to each other along an arced line of motion, said insulator comprising:
a mounting surface defining a mounting plane for coupling to the mounting base;
a core portion extending from said mounting surface along an axis and formed of elastomeric material for compression between the mounting base and the striking base when the striking base contacts said insulator during movement of the mounting base relative to the striking base along the arced line of motion; and
a ridge portion extending laterally from said core portion about said axis and extending circumferentially along said core portion at an acute angle relative to said mounting plane for guiding the compression of said insulator along said arced line of motion.

15. The insulator as set forth in claim 14 wherein said ridge portion extends helically about said axis to define a plurality of ridge sections with a valley formed between consecutive ridge sections.

16. The insulator as set forth in claim 15 wherein said valley extends helically about said axis interposed with said ridge sections to define a plurality of valley sections.

17. The insulator as set forth in claim 16 wherein each of said ridge sections has a crest with each crest spaced axially along said axis and wherein each of said valley sections extends arcuately between consecutive crests.

18. The insulator as set forth in claim 14 wherein each ridge section extends one revolution about said core portion.

19. The insulator as set forth in claim 18 wherein each ridge section extends continuously about said core portion.

20. The insulator as set forth in claim 14 wherein said ridge portion extends outwardly from said core portion.

21. The insulator as set forth in claim 14 wherein said core portion defines a bore with said ridge portion extending inwardly from said core portion into said bore.

22. The insulator as set forth in claim 14 wherein said core portion defines a bore and wherein said ridge portion is further defined as a first ridge portion and a second ridge portion with said first ridge portion extending outwardly from said core portion and with said second ridge portion extending inwardly from said core portion into said bore.

23. The insulator as set forth in claim 22 wherein said first and second ridge portions are axially aligned with each other along said axis.

24. The insulator as set forth in claim 14 wherein said core portion and said ridge portion are integral with each other.

25. The insulator as set forth in claim 14 wherein said insulator is formed of microcellular polyurethane.
